(19) United States
(12) Patent Application Publication
(10) Pub. No.: US 2007/0109469 A1
(43) Pub. Date: May 17, 2007

(54) Liquid crystal display device and method of fabricating the same

(75) Inventors: Jin Jeon, (US); Cheong Haeng Lee, (US); Jun Young Lee, (US); Sung Wook Kang, (US); Jin Young Choi, (US)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/516,226

(22) Filed: Sep. 6, 2006

(30) Foreign Application Priority Data
Nov. 11, 2005 (KR) 2005-0108095

(51) Int. Cl. G02F 1/1333

(52) U.S. Cl. 349/110

(57) ABSTRACT

A liquid crystal display (LCD) device is provided. The LCD includes first and second substrates, a gate line formed on the first substrate, a data line formed on the first substrate with the data line intersecting the gate line, a thin film transistor (TFT) formed on the first substrate and connected to the gate line and to the data line, a storage line formed on the substrate which is parallel with the gate line, and a pixel electrode formed on the first substrate and connected to a drain electrode of the TFT. The LCD further includes a black matrix formed on the second substrate, with the black matrix overlapping a channel of the TFT.

### CROSS-REFERENCE TO RELATED PATENT APPLICATION

This application claims priority from Korean Patent Application No. 2005-0108095, filed Nov. 11, 2005, the disclosure of which is hereby incorporated by reference herein in its entirety.

### BACKGROUND OF THE INVENTION

1. Field of the Invention

The present invention relates to a liquid crystal display (“LCD”) device and a method of fabricating the same, and more particularly, to an LCD device capable of providing a high aperture ratio, and a method of fabricating the same.

2. Description of the Related Art

A cathode ray tube (“CRT”) is a commonly used display device due to performance and cost. However, a widely used alternative to the CRT display device is the LCD device because, unlike an LCD device, a CRT device, is difficult to manufacture as a small, thin and lightweight device.

An LCD device displays an image by controlling the light transmittance through a liquid crystal layer by applying an electric field. The LCD device includes a thin film transistor (“TFT”) substrate and a color filter substrate assembled to each other with a liquid crystal layer disposed therebetween. However, certain defects may occur during the manufacturing of a conventional LCD device which may prevent a high aperture ratio for the LCD from being obtained. For example, when manufacturing an LCD device, the LCD device may be formed having a top, bottom, right and left margin due to a misalignment caused by assembly equipment used during an assembly process. Moreover, in conventional LCD's a black matrix is formed in a matrix format to overlap a gate line and a data line and simultaneously to overlap a pixel electrode and a channel of a TFT.

In an attempt to provide a high aperture ratio, a conventional LCD device 12, as illustrated in FIG. 1, has been developed that is capable of eliminating the above-mentioned right and left margin by causing a pixel electrode 202 and a data line 132 to overlap through use of an organic insulating layer.

A TFT substrate of the LCD device 12 includes a gate line 52 and the data line 132 formed to intersect each other, a TFT 45 formed at an intersection of the gate line 52 and data line 132, the pixel electrode 202 connected to the TFT 45, a storage line 72 formed in parallel with the gate line 52, and a storage electrode 82 connected to the storage line 72, all of which are formed on a substrate.

A color filter substrate includes a black matrix 242 for preventing light leakage, a color filter for forming colors, an overcoat for protecting the color filter, a common electrode for forming an electric field together with the pixel electrode 202, and a column spacer for maintaining a cell gap between the color filter substrate and the TFT substrate, all of which are formed on a different substrate from that in which the TFT substrate was formed.

However, in the above conventional LCD device 12, light leakage may occur at a region A between the gate line 52 and the storage electrode 82, and light leakage current may be generated from the channel of the TFT. In other words, the above LCD 12 can eliminate right and left margin but not the top and bottom margin.

Another conventional LCD device which has been developed in an attempt to provide a high aperture ratio is formed such that adjacent two pixel electrodes overlap one gate line. Such an LCD device, however, can eliminate the top and bottom margin but not the right and left margin.

Thus, there is a need for an LCD device capable of providing a high aperture ratio by eliminating top, bottom, right and left margin caused by a misalignment of assembly equipment during an LCD device assembly process, and for a method of fabricating the same.

### SUMMARY OF THE INVENTION

According to an exemplary embodiment of the present invention, an LCD device is provided The LCD device includes first and second substrates, a gate line formed on the first substrate, a data line formed on the first substrate with the data line intersecting the gate line, a TFT formed on the first substrate and connected to the gate line and to the data line, a storage line formed on the substrate with the storage line being parallel with the gate line, a pixel electrode formed on the first substrate and connected to a drain electrode of the TFT, wherein the pixel electrode comprises two separate pixel electrodes that are adjacent to each other in a longitudinal direction on the storage line. The LCD device further includes a black matrix formed on the second substrate with the black matrix overlapping a channel of the TFT.

The pixel electrode may overlap a region between the gate line, and a storage electrode connected to the storage line.

The LCD device may further comprise an organic insulating layer formed on the first substrate, for insulating the pixel electrode from the data line.

The LCD device may further comprise a dummy gate pattern that is formed on the first substrate, overlaps the data line, and has a line width wider than that of the data line.

The line width of the data line may be about 2 to about 10 μm and the line width of the dummy gate pattern may be about 6 to about 14 μm.

Both sides of the pixel electrode may overlap at least one of the data line and the dummy gate pattern.

The LCD device may further comprise a storage capacitor formed on the first substrate, wherein the storage capacitor is formed by overlapping the storage electrode connected to the storage line and the drain electrode of the TFT with an insulating layer of at least one layer disposed therebetween.

The LCD device may further comprise color filters that are formed on the second substrate, overlap the pixel electrode, and are separated from each other at predetermined intervals at a region corresponding to at least one of the data line and the storage line.

According to another exemplary embodiment of the present invention, an LCD device is provided. The LCD device includes a TFT substrate including a first substrate, a gate line and a data line that are formed on the first substrate and intersect each other, a storage line parallel with the gate line, a TFT connected to the gate line and data line, a pixel electrode connected to a drain electrode of the TFT, and a color filter substrate including a second substrate facing the first substrate with a liquid crystal material disposed therebetween The LCD device further includes a black matrix overlapping a channel of the TFT, wherein the pixel electrode comprises two separate pixel electrodes that are adjacent to each other in a longitudinal direction on the storage line.

The two pixel electrodes of the TFT substrate may overlap a region between the gate line, and a storage electrode connected to the storage line.

The TFT substrate may further comprise an organic insulating layer for insulating the two pixel electrodes from the data line.

The TFT substrate may further comprise a dummy gate pattern that overlaps the data line and has a line width wider than that of the data line.

Both sides of the two pixel electrodes may overlap at least one of the data line and the dummy gate pattern.

The TFT substrate may further comprise the storage capacitor formed by overlapping the storage electrode connected to the storage line and the drain electrode of the TFT with an insulating layer of at least one layer disposed therebetween.

The color filter substrate may further comprise color filters which overlap the two pixel electrodes and are separated from each other at predetermined intervals at a region corresponding to at least one of the data line and the storage line.

According to another exemplary embodiment of the present invention, a method of fabricating an LCD device is provided. The method includes the steps of preparing on a first substrate a TFT array including a gate line and data line intersecting each other, a storage line parallel with the gate line, a TFT connected to the gate line and data line, and two pixel electrodes connected to a drain electrode of the TFT. The method further includes preparing on a second substrate a color filter array including a black matrix overlapping a channel of the TFT, and assembling the first and second substrates with a liquid crystal disposed therebetween, wherein the pixel electrode comprises two separate pixel electrodes that are adjacent to each other in a longitudinal direction on the storage line.

The step of preparing on the first substrate the TFT array may comprise forming a gate pattern including the gate line, a gate electrode of the TFT, the storage line and a storage electrode, forming a gate insulating layer to cover the gate pattern, forming an active layer of the TFT and an ohmic contact layer on the gate insulating layer, forming a data pattern including the data line, a source electrode of the TFT and the drain electrode of the TFT on the first substrate where the active layer and the ohmic contact layer are formed, forming an organic insulating layer to cover the data pattern, and forming the two pixel electrodes on the organic insulating layer.

The step of preparing on the first substrate the TFT array may further comprise forming a dummy gate pattern that overlaps the data line and has a line width wider than that of the data line at the same time when forming the gate pattern.

The step of forming the two pixel electrodes is, for example, forming the pixel electrodes such that both sides of the two pixel electrodes overlap at least one of the data line and the dummy gate pattern.

The step of forming the pixel electrode is, for example, forming the two pixel electrodes such that the pixel electrode overlaps a region between the gate line, and the storage electrode connected to the storage line.

The step of preparing on the first substrate the TFT array may further comprise the forming a storage capacitor formed by overlapping the storage electrode connected to the storage line and the drain electrode of the TFT with an insulating layer of at least one layer.

The step of preparing on the second substrate the color filter array may further comprise forming a plurality of color filters that overlap the two pixel electrodes and are separated from each other at predetermined intervals at a region corresponding to at least one of the data line and the storage line.

### BRIEF DESCRIPTION OF THE DRAWINGS

FIG. 1 is a plane view of a conventional LCD device;

FIG. 2 is a plane view of an LCD device according to an exemplary embodiment of the present invention;

FIG. 3 is a cross-sectional view taken along line III-III′ shown in FIG. 2; and

FIGS. 4A to 4J are views for explaining a process of fabricating an exemplary embodiment of an LCD device according to the present invention.

### DETAILED DESCRIPTION OF THE PREFERRED EMBODIMENTS

The exemplary embodiments of the present invention will now be described with reference to the attached drawings.

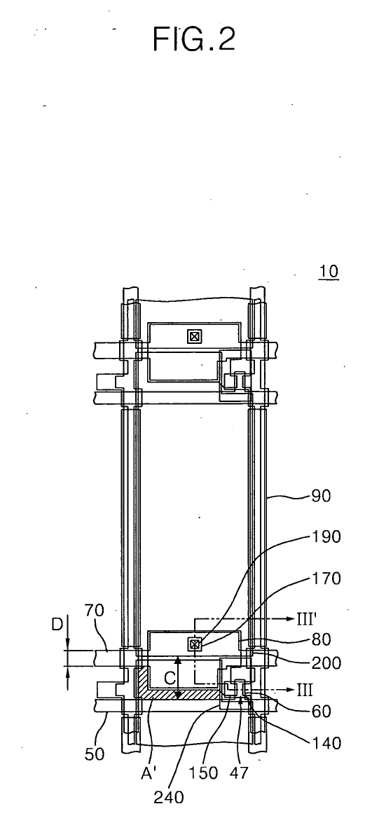

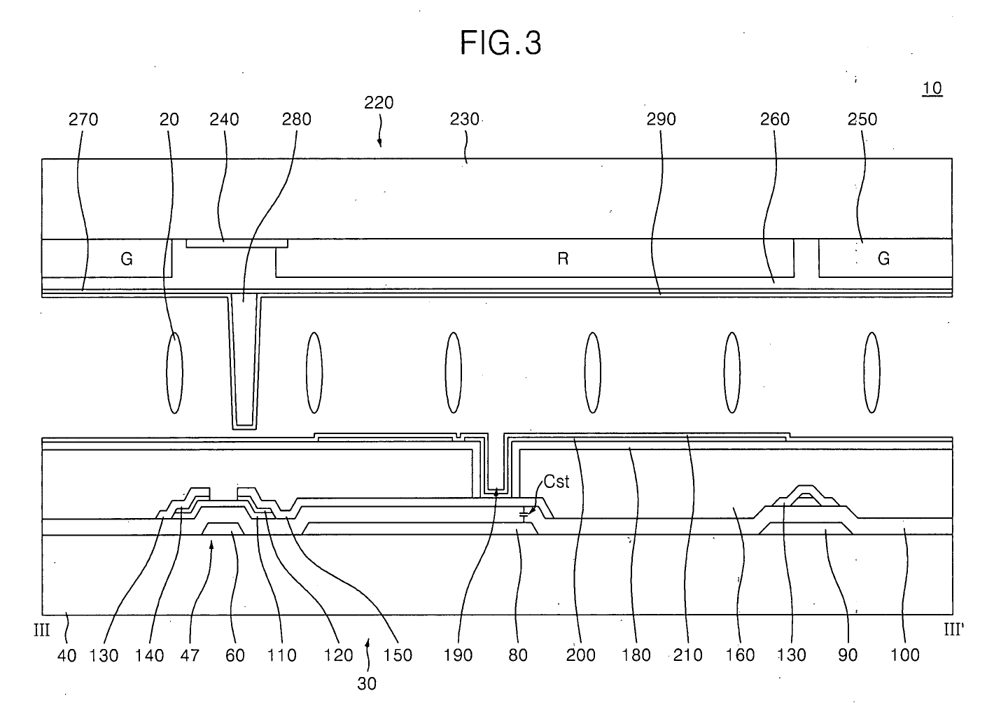

FIG. 2 is a plane view of an LCD device according to an exemplary embodiment of the present invention, and FIG. 3 is a cross-sectional view taken along line III-III′ shown in FIG. 2.

Referring to FIGS. 2 and 3, an LCD device 10 includes a liquid crystal 20 for adjusting the amount of incident light transmittance, and a TFT substrate 30 and a color filter substrate 220 assembled to each other with the liquid crystal 20 disposed therebetween.

The liquid crystal 20 adjusts the amount of light transmittance by the difference between a pixel voltage from a pixel electrode 200 and a common voltage from a common electrode 270. The liquid crystal 20 is made of a material having dielectric anisotropy and refractive index anisotropy.

The TFT substrate 30 includes a gate line 50 and a data line 130 that intersect each other, a TFT 47 formed at an intersection of the gate line 50 and data line 130, the pixel electrode 200 connected to the TFT 47, a storage line 70 formed in parallel with the gate line 50, a storage electrode 80 protruded from the storage line 70, a dummy gate pattern 90 formed to overlap the data line 130 and the pixel electrode 200, and a first alignment layer 210 formed to cover the pixel electrode 200 and a passivation layer 180, all of which are formed on a first substrate 40.

The gate line 50 is formed in a single layer structure composed of a metal selected from but not limited to chromium (Cr), Cr alloy, aluminum (Al), Al alloy, molybdenum (Mo), Mo alloy, silver (Ag), or Ag alloy, or in a multi-layered structure composed of a combination of these metals. The gate line 50 supplies a gate ON/OFF voltage received from a gate driving circuit to a gate electrode 60 of the TFT 47 connected thereto. One side of the gate line 50 is extended and connected to the gate driving circuit.

The data line 130 is formed in a single layer structure or a multi-layered structure composed of but not limited to Cr, Cr alloy, Al, Al alloy, Mo, Mo alloy, Ag, Ag alloy, titanium Ti, Ti alloy, or a combination thereof. The data line 130 supplies a data voltage received from a data driving circuit to a source electrode 140 of the TFT 47 connected thereto. One side of the data line 130 is extended and connected to the data driving circuit. To eliminate the right and left margin formed during an assembly process, the data line 130 is formed to overlap the pixel electrode 200. The line width of the data line 130 is for example about 2 to about 10 μm.

The TFT 47 supplies the data voltage received from the data line 130 to the pixel electrode 200 in response to the gate ON/OFF voltage received from the data line 50. The TFT 47 is formed to face the gate electrode 60 connected to the gate line 50 and the source electrode 40 connected to the data line 130. The TFT 47 includes a drain electrode 150 connected to the pixel electrode 200, and an active layer 110 and an ohmic contact layer 120 that overlap the gate electrode 60 with a gate insulating layer 100 disposed therebetween.

The gate electrode 60 is formed of the same material as the gate line 50 on the same plane as the gate line 50. The gate electrode 60 protrudes from the gate line 50 and turns ON/OFF the TFT 47 by using the gate ON/OFF voltage from the gate line 50.

The source electrode 140 is formed of the same material as the data line 130 on the same plane as the data line 130. The source electrode 140 protrudes from the data line 130 and supplies the data voltage received from the data line 130 to the drain electrode 150 via the channel of the TFT 47.

The drain electrode 150 is formed of the same material as the data line 130 on the same plane as the data line 130. The drain electrode 140 supplies the data voltage received from the source electrode 140 to the pixel electrode 200 connected thereto through a via 170 penetrating an organic insulating layer 160 and through a contact hole 190 penetrating the passivation layer 180.

The active layer 110 is formed of amorphous silicon (“a-Si”) and forms the channel of the TFT 47. Alternatively, in other embodiments, the active layer. 110 may be formed of polycrystalline silicon to form the channel of the TFT 47.

The ohmic contact layer 120 is formed for an ohmic contact of the source electrode 140 and the drain electrode 150 with active layer 110. An impurity, e.g. an n+ impurity added to the a-Si is doped into the ohmic contact layer 120.

The pixel electrode 200 is made of a transparent metal such as e.g., indium-tin-oxide (“ITO”) or indium-zinc-oxide (“IZO”) and supplies the pixel voltage received from the drain electrode 150 to the liquid crystal 20. To eliminate the right and left margin caused by a misalignment of assembly equipment during an assembly process, both sides of the pixel electrode 200 overlap the data line 130 and the dummy gate pattern 90. Accordingly, the organic insulating layer 160 having a low dielectric constant such as e.g., acryl, polyimide, or benzo-cyclo-butene (“BCB”) and the passivation layer 180 such as e.g., (silicon nitride) SiNx are formed under the pixel electrode 200. The organic insulating layer 160 and the passivation layer 180 insulate the pixel electrode 200 from the data line 130. At this point , only the organic insulating layer 160 without the passivation layer 180 may be formed. The right and left margin may be eliminated by causing the pixel electrode 200 to further overlap the data line 130 without forming the dummy gate pattern 90. Furthermore, to eliminate the top and bottom margin caused by a misalignment of assembly equipment during an assembly process, sides of the pixel electrode 200 overlap the storage line 70 and the storage electrode 80. Since such a structure causes the pixel electrode 200 to cover region A′ between the gate line 50, and the storage line 70 and the storage electrode 80, a high aperture ratio can be provided. Two pixel electrodes 200 that are adjacent to each other in a longitudinal direction and which overlap one storage line 70. However, it is difficult to form a distance between the two adjacent pixel electrodes 200 to be less than about 2.5 μm. Even if the distance between the two adjacent pixel electrodes 200 is formed which less than about 2.5 μm, a connection and interference may occur between the two pixel electrodes 200. Accordingly, it is preferable that the distance between the two adjacent pixel electrodes 200 in a longitudinal direction is more than about 2.5 μm.

The storage line 70 is formed of the same material as the gate line 50 on the same plane as the gate line 50. The storage line 70 supplies the common voltage received from a common voltage generator to the storage electrode 80. To eliminate the top and bottom margin caused by a misalignment of assembly equipment during an assembly process, the storage line 70 is formed to overlap the two pixel electrodes 200. In other words, the two pixel electrodes 200 are adjacent and separated from each other in a longitudinal direction on one storage line 70. Therefore, a low kick-back voltage can be provided because two pixel electrodes 200 adjacently formed in a longitudinal direction do not overlap one gate line 50. In addition, storage line 70 may have a large line width D. For example, the line width D of the storage line 70 is about 6 to about 10 μm. This is because an overlay between the storage line 70 and the pixel electrode 200 should be considered and the distance between the two adjacent pixel electrodes 200 may be, for example, about 2.5 μm or more. The aperture ratio can be further enhanced by reducing the size of the storage electrode 80 because the kick-back voltage can be lowered as the line width D of the storage line 70 is increased. Since one storage line 70 overlaps the two pixel electrodes 200 that are adjacent to each other in a longitudinal direction, a distance C between the pixel electrode 200 and the gate line 50 becomes greater, thereby decreasing the parasite capacitance. Therefore, if the kick-back voltage is maintained at the same level as the conventional LCD device, the size of the storage electrode 80 can be reduced and the aperture ratio can be further enhanced.

The storage electrode 80 is formed of the same material as the gate line 50 on the same plane as the gate line 50. The storage electrode 80 overlaps the drain electrode 150 of the TFT 47 with the gate insulating layer 100 disposed therebetween, thereby forming a storage capacitor Cst. The storage electrode 80 maintains the pixel voltage applied to the pixel electrode 200 during one frame by using the common voltage from the storage line 70.

The dummy gate pattern 90 is formed of the same material as the gate line 50 on the same plane as the gate line 50. To eliminate the right and left margin caused by a misalignment of assembly equipment during an assembly process, the dummy gate pattern 90 overlaps both sides of the pixel electrode 200. In this embodiment, the line width of the dummy gate pattern 90 is wider than that of the data line 130. For example, the line width of the dummy gate pattern 90 may be about 6 to about 14 μm. However, if the data line 130 and the pixel electrode 200 further overlap, the dummy gate pattern 90 may not be formed.

The first alignment layer 210 controls the alignment status of the liquid crystal 20 by an interface effect. The alignment layer 210 is formed with a thickness of several hundred Å to several thousand Å and has a high resistivity value to keep electric stability between the liquid crystal 20 and the pixel electrode 200.

The color filter substrate 220 includes a black matrix 240 for preventing a light leakage current of the TFT 47, a color filter 250 for forming colors, an overcoat 260 for covering the black matrix 240 and the color filter 250, a common electrode 270 formed on the overcoat 260, a column spacer 280 for maintaining a cell gap, and a second alignment layer 290 for covering the common electrode 270 and the column spacer 280, all of which are formed on a second substrate 230.

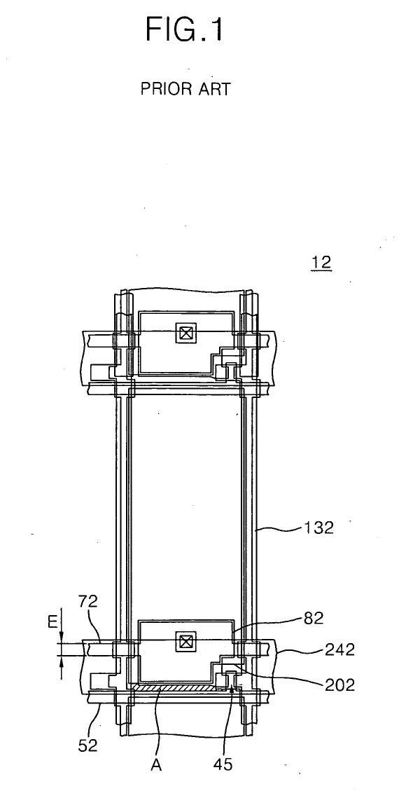

The black matrix 240 is formed of an opaque organic material or an opaque metal to prevent the light leakage current of the TFT 47 by blocking direct light irradiation to the channel of the TFT 47. Unlike the conventional LCD device 12 of FIG. 1, the black matrix 240 of the present embodiment, overlaps only the channel of the TFT 47. Therefore, the LCD device 10 can provide a high aperture ratio.

The color filter 250 includes red and green color filters R and G and a blue color filter to form colors. The red, green and blue color filters show red, green and blue by absorbing or transmitting light of a specific wavelength through red, green and blue pigments, respectively. At this point, various colors are expressed through the additive mixture of red, green and blue lights respectively transmitting the red, green and blue color filters. The color filters are arranged in a stripe shape in which the red, green and blue color filters are formed in a row. That is, the red and green color filters R and G and the blue color filter are alternatively formed on the basis of the data line 130. In this case, the red and green color filters R and G and the blue color filter may be separated on the basis of the storage line 70.

The overcoat 260 is formed of a transparent organic material and protects the color filter 250. The overcoat 260 is formed for excellent step coverage of the common electrode 270.

The common electrode 270 is formed of a transparent metal such as ITO or IZO and supplies the common voltage from the common voltage generator to the liquid crystal 20. The common electrode 270 receives the common voltage through a common electrode line formed on the TFT substrate 30 and through a short formed between the TFT substrate 30 and the color filter substrate 220.

The column spacer 280 for maintaining a cell gap is formed of an organic or inorganic material and overlaps the black matrix 240. It is also possible to maintain the cell gap by scattering a ball spacer between the TFT substrate 30 and the color filter substrate 220 without forming the column spacer 280.

The second alignment layer 290 is formed of the same material as the first alignment layer 210 formed on the TFT substrate 30. The second alignment layer 290 controls the arrangement status of the liquid crystal 20 by the interface effect. The second alignment layer 290 is formed with a thickness of several hundred angstroms (Å) to several thousand angstroms (Å) and has a high resistivity value to keep electric stability between the liquid crystal 20 and the common electrode 270.

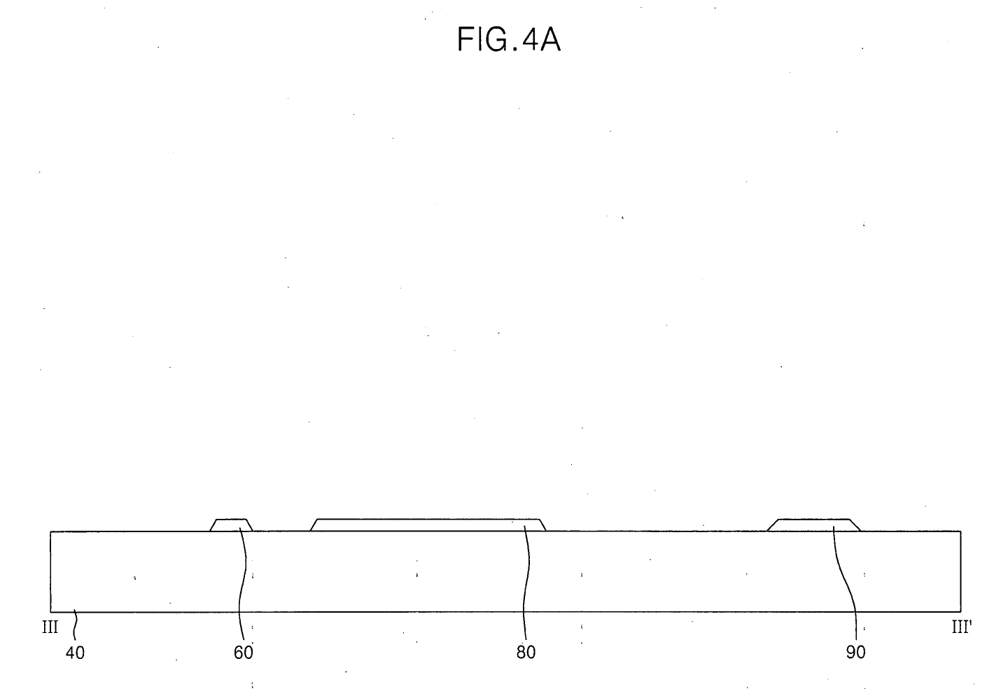

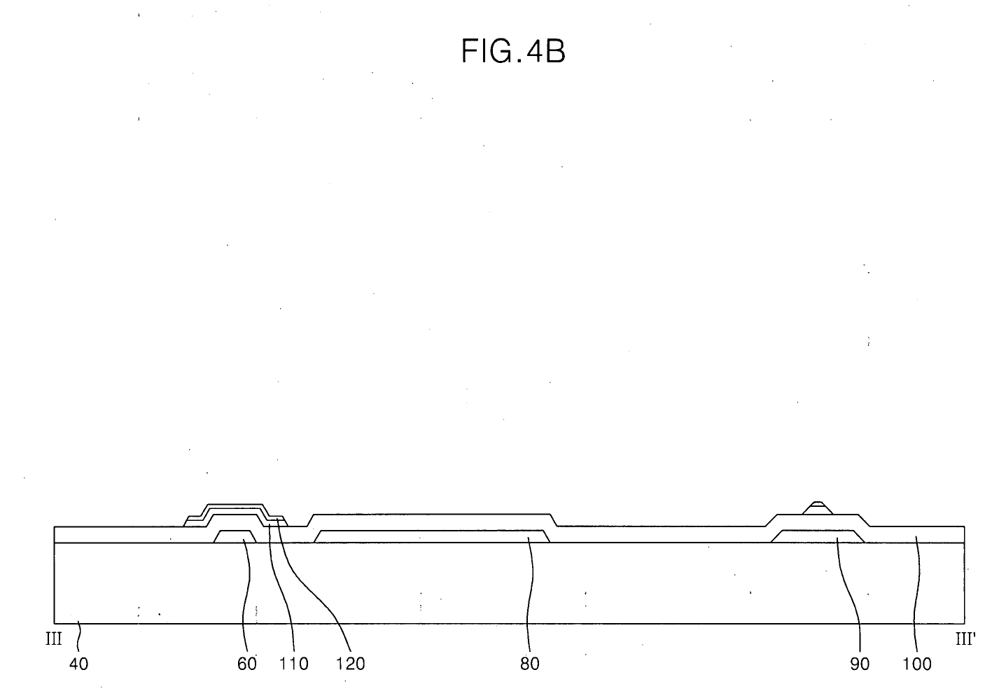

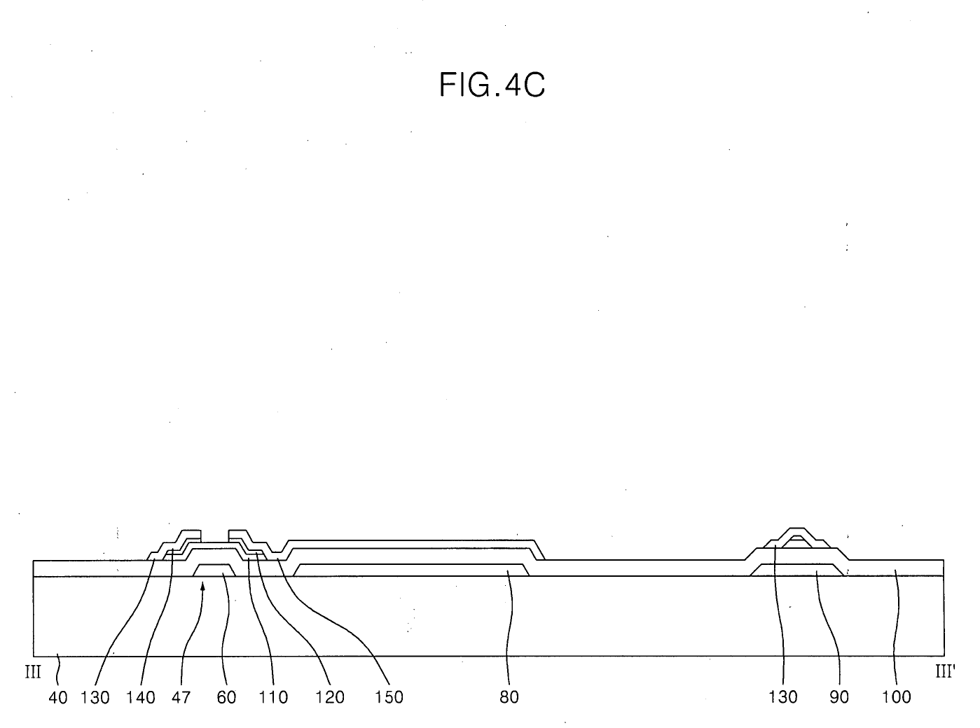

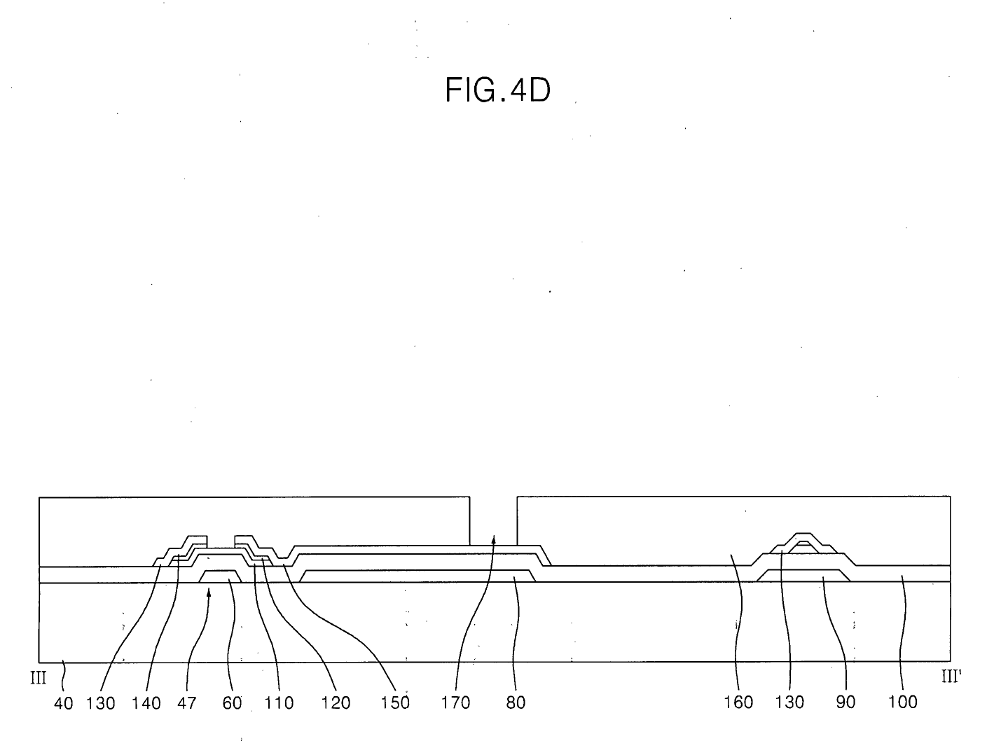

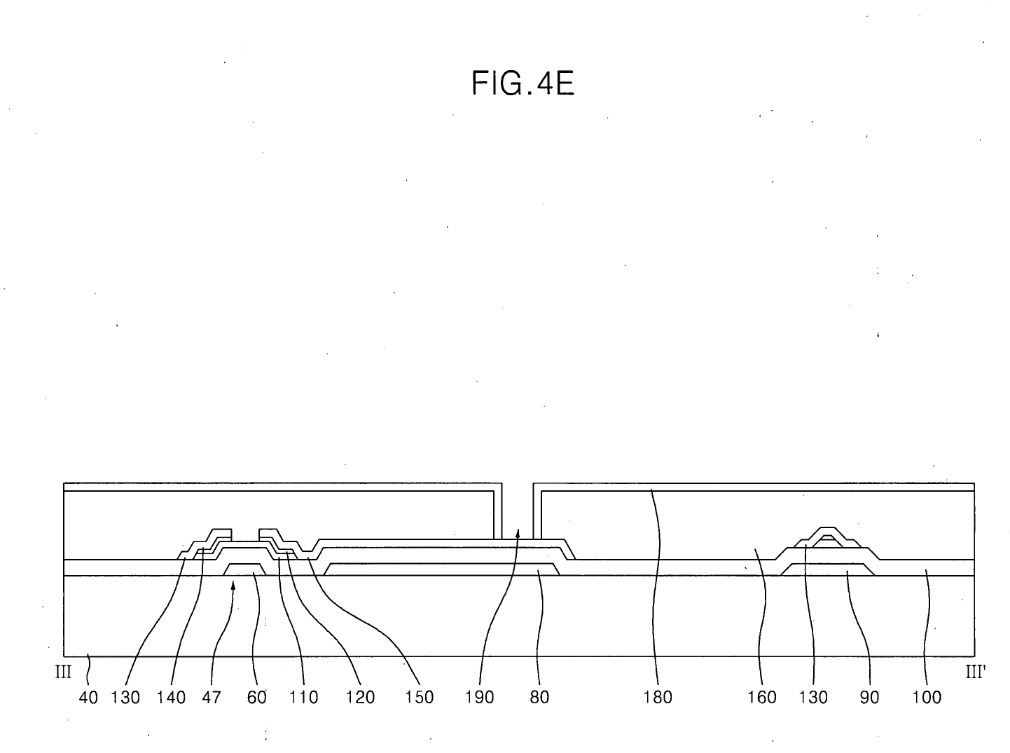

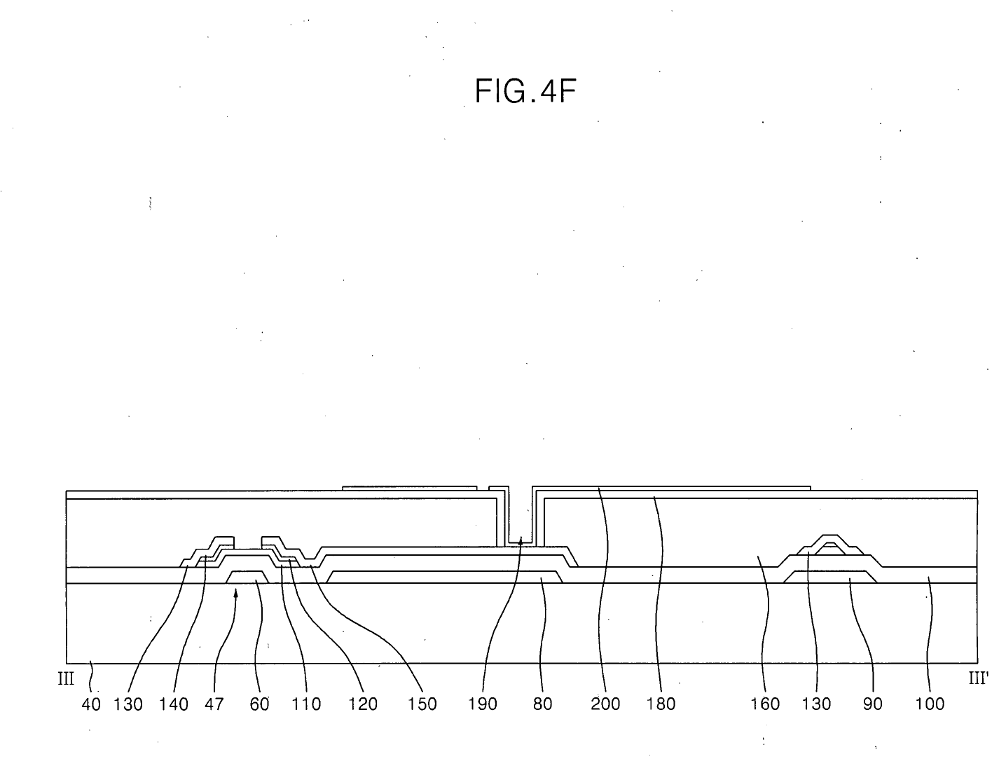

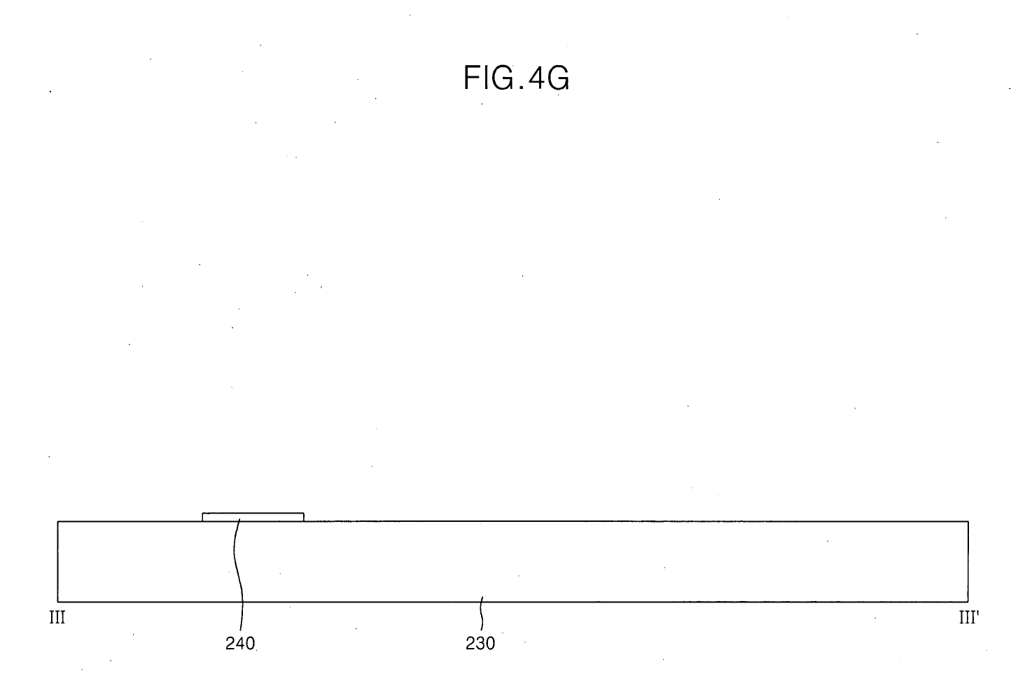

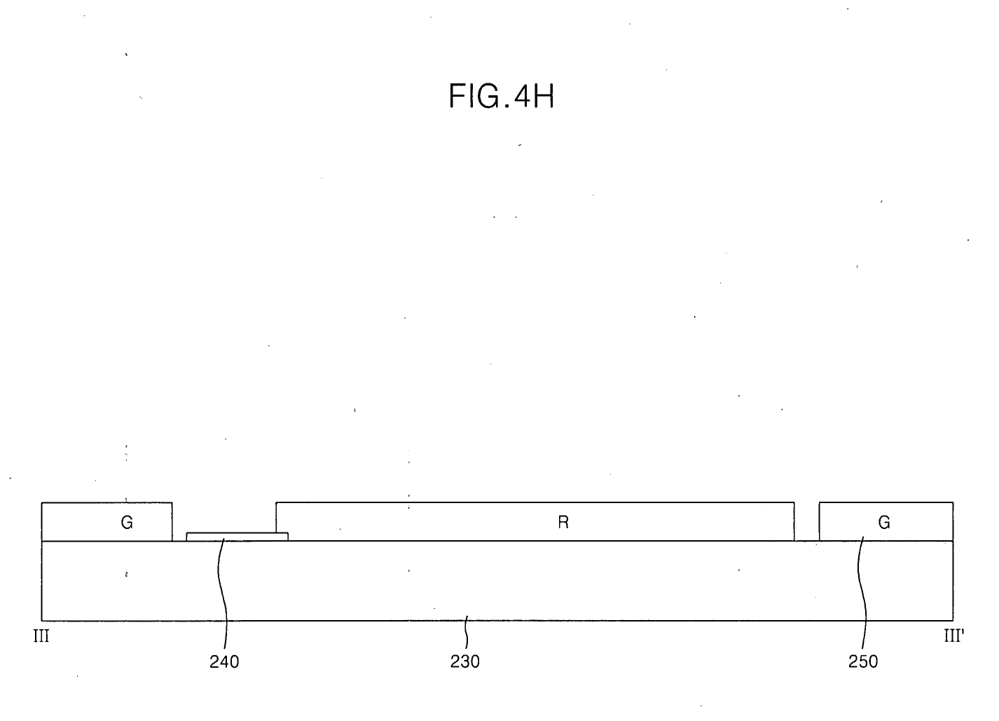

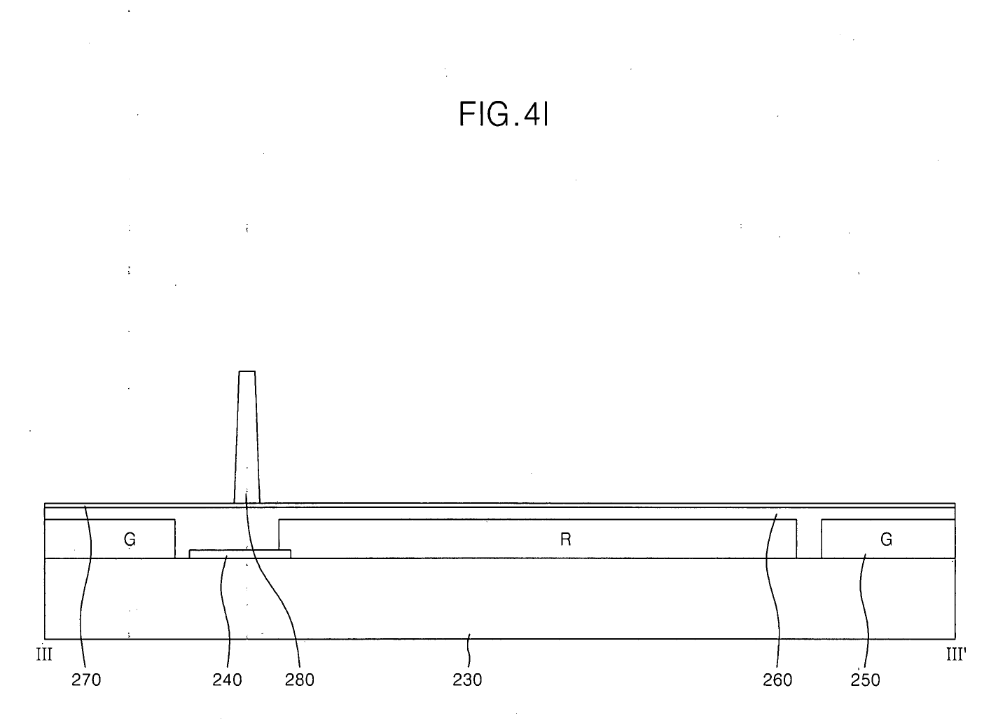

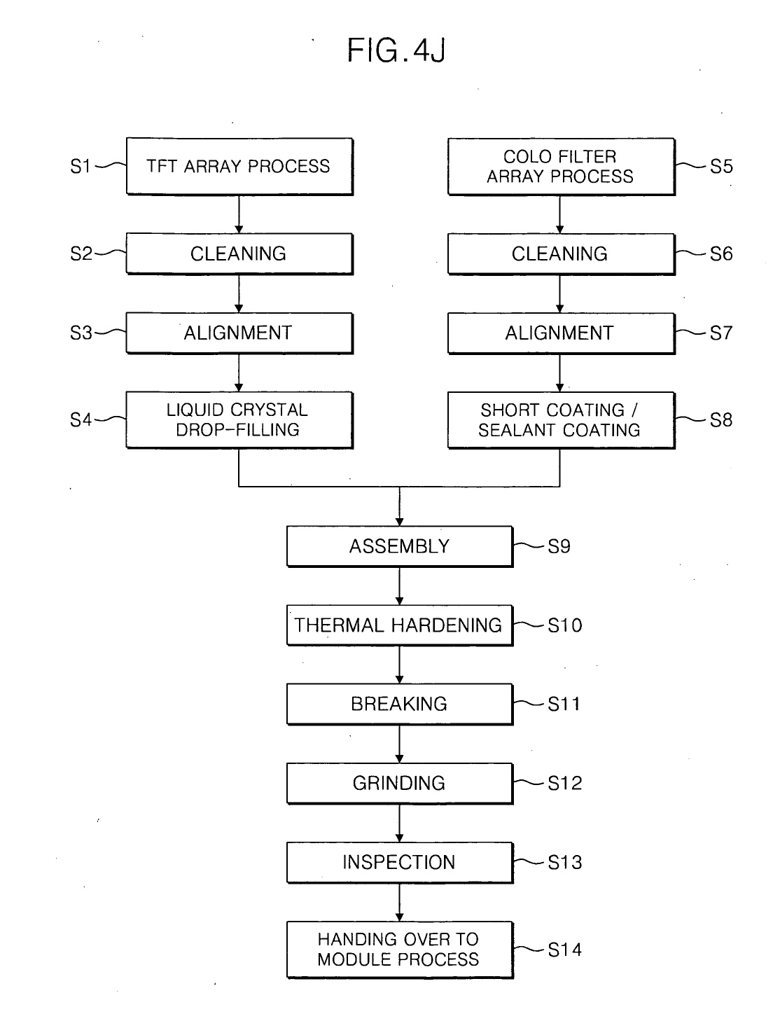

The above-described LCD device 10 is formed through fabricating processes shown in FIGS. 4A to 4J. FIGS. 4A to 4F illustrate a TFT array process, FIGS. 4G to 4I a color filter array process, and FIG. 4J a cell process.

The TFT array process will now be described hereinbelow in conjunction with FIGS. 4A to 4F.

Referring to FIG. 4A, a gate pattern including the gate line, the gate electrode 60, the storage line, the storage electrode 80 and the dummy gate pattern 90 is formed in a single layer or multi-layered structure on the first substrate 40 made of a glass or plastic material.

A gate metal layer comprised of but not limited to Cr, Cr alloy, Al, Al alloy, Mo, Mo alloy, Ag, Ag alloy or combinations thereof is formed in a single layer or multi-layered structure on the first substrate 40 by using a sputtering method. For instance, Al is deposited with a thickness of about 2,500 Å and Cr is deposited thereon with a thickness of about 1,000 Å. The gate metal layer is then patterned by a photolithography process using a gate mask, thereby forming the gate pattern of a single layer or multiple layers.

Referring to FIG. 4B, the gate insulating layer 100, the active layer 110 and the ohmic contact layer 120 are formed after the gate pattern is formed.

The gate insulating layer 100 composed of, for example, silicon nitride (SiNx) or silicon oxide (SiOx), the active layer 110 composed of, for example, a-Si, and the ohmic contact layer 120 composed of, for example, a-Si doped with an n-type impurity are sequentially deposited using a plasma enhanced chemical vapor deposition (“PECVD”) method. The gate insulating layer 100 may be formed by depositing SiNx using silane (SiH₄), hydrogen (H₂) and ammonia (NH₃) with a thickness of about 4,500 Å. Thereafter, a-Si may be deposited with a thickness of about 1,500 Å by using SiH₄ and H₂ Additionally, a-Si doped with phosphor P is deposited using SiH₄, H₂ and phosphine (PH₃) with a thickness of about 600 Å. The active layer 110 and the ohmic contact layer 120 are then formed by a photolithography process using an active mask.

Referring to FIG. 4C, after forming the gate insulating layer 100, the active layer 110 and the ohmic contact layer 120, a data pattern including the data line 130, the source electrode 140 and the drain electrode 150 is formed in a single layer or multi-layered structure.

A data metal layer comprised of but not limited to Cr, Cr alloy, Al, Al alloy, Mo, Mo alloy, Ag, Ag alloy, Ti, Ti alloy, or a combination thereof is formed on the gate insulating layer 100 and the ohmic contact layer 120 in a single layer or multi-layered structure by using a sputtering method. For instance, Cr is deposited with a thickness of about 1,500 Å. The data metal layer is then patterned by a photolithography process using a data mask, thereby forming the data pattern of a single layer or multiple layers. Thereafter, the active layer 110 is exposed by dry-etching the ohmic contact layer 120 exposed between the source electrode 140 and the drain electrode 150. At this point, the active layer 110 is slightly etched as well and it may also be over-etched.

Alternatively, the gate insulating layer 100, the active layer 110, the ohmic contact layer 120 and the data pattern may be simultaneously formed by using one partial exposure mask without using the different active mask and data mask. The partial exposure mask is a diffraction exposure mask or semi-transmission mask.

Referring to FIG. 4D, after forming the data pattern, the organic insulating layer 160 including the via 170 is formed.

The organic insulating layer 160 is formed by depositing an organic material such as,for example, BCB, polyimide, or acryl. For example, acryl is deposited with a thickness of about 2 μm and the via 170 is formed by a photolithography process using an organic insulating mask, thereby exposing the drain electrode 150.

Referring to FIG. 4E, the passivation layer 180 including the contact hole 190 is formed after the organic insulating layer 160 is formed.

The passivation layer 180 composed of, for example, SiNx or SiOx is deposited on the organic insulating layer 160 by using a PECVD method. For example, SiNx using SiH₄, H₂ and NH₃ is deposited with a thickness of about 2,500 Å. The contact hole 190 is formed by a photolithography process using the passivation layer mask, thereby exposing the drain electrode 150. However, only the organic insulating layer 160 may be formed without forming the passivation layer 180.

Referring to FIG. 4F, after forming the passivation layer 180, the pixel electrode 200 is formed.

A transparent conductive metal layer such as ITO or IZO is formed on the passivation layer 180 by using a sputtering method. The transparent conductive metal layer may be formed by depositing the ITO with a thickness of about 700 Å. The pixel electrode 200 is formed by patterning the transparent conductive metal layer by a photolithography process using a pixel electrode mask.

The color filter array process will now be described with reference to FIGS. 4G to 41.

Referring to FIG. 4G, the black matrix 240 is formed on the second substrate 230 made of a glass or plastic material.

A black layer of Cr or Cr alloy is deposited in a single layer or multi-layered structure by a sputtering method. For instance, chromium oxide (CrOx) is deposited with a thickness of about 500 Å and Cr is deposited with a thickness of about 1,500 Å. The black matrix 240 is then formed by a photolithography process using a black matrix mask. Alternatively, the black matrix 240 may be formed by using an organic material instead of Cr or Cr alloy. That is, an opaque organic material may be deposited with a thickness of about 1.5 μm and then the black matrix 240 may be formed by a photolithography process using the black matrix mask.

Referring to FIG. 4H, the color filter 250 is formed after the black matrix 240 is formed.

More particularly, a red color layer having negative photosensitivity is coated and the red color filter R is formed by a photolithography process using a red color filter mask. Thereafter, a green color layer having negative photosensitivity is deposited and the green color filter G is formed by a photolithography process using a green color filter mask. Next, a blue color layer having negative photosensitivity is deposited and the blue color filter is formed by a photolithography process using a blue color filter mask.

Referring to FIG. 4I, after forming the color filter 250, the overcoat 260, the common electrode 270 and the column spacer 280 are formed.

The overcoat 260 is formed by depositing an organic material. The organic material may be coated with a thickness of about 1.2 μm to form the overcoat 260. The common electrode 270 is formed by depositing a metal such as ITO or IZO using a sputtering method. For example, the common electrode 270 is formed by depositing the ITO with a thickness of about 700 Å. Next, a column spacer layer is formed by coating an organic material. For example, the column spacer layer is formed by coating the organic material with a thickness of about 4 μm. The column spacer 280 is formed by a photolithography process using a column spacer mask.

The cell process illustrated in FIG. 4J is performed using the first substrate 40 where the TFT array process has been completed and the second substrate 230 where the color filter array process completed.

Referring to FIG. 4J, the first substrate 40 where the TFT array process (step S1) has been completed is cleaned using a cleaner (step S2), and the second substrate 230 where the color filter array process (step S5) has been completed is cleaned using a cleaner (step S6).

The first and second substrates are cleaned by irradiating ultraviolet rays. The wavelength of the ultraviolet rays may be for example, from about 200 to about 420 nm. Next, the first and second substrates are cleaned by using a brush and a tetramethylammonium hydroxide (“TMAH”) solution. The TMAH solution serves as a lubricant so that the brush rotating at the surfaces of the first and second substrates can softly rub with each of these surfaces. In addition, the TMAH solution serves as a cleaner so that the brush can clean the first and second substrates. The first and second substrates are then further cleaned using ultrapure water and dried using an air knife.

Thereafter, the first alignment layer is formed on the cleaned first substrate (step S3) and the second alignment layer is formed on the cleaned second substrate (step S7).

An alignment solution including a horizontal alignment material using a resin is coated on the first and second substrates. Polyamic acid is used as the horizontal alignment material. Alternatively, a vertical alignment material of polyamic acid may be used instead of the horizontal alignment material. In this case, it is preferable to appropriately adjust the viscosity and solubility of the horizontal alignment material with respect to a solvent. Moreover, the horizontal alignment material may be coated with a thickness of about 0.05 to about 0.1 μm to prevent a voltage applied by the first and second alignment layers from being dropped. The alignment solution is calcined to eliminate the solvent included therein, thereby forming the first and second alignment layers of polyimide.

Next, the liquid crystals are drop-filled on a display region provided in the TFT array of the first substrate (step S4). Alternatively, a liquid crystal injecting process may be used instead of the liquid crystal filling process. If the liquid crystal injecting process is used, however, the order and method of the process may be changed.

In this exemplary embodiment, liquid crystals having positive dielectric anisotropy are drop-filled on the display region provided in the TFT array of the first substrate. Alternatively, liquid crystals having negative dielectric anisotropy may be used.

When the liquid crystals are drop-filled on the display region provided in the TFT array of the first substrate, a short and a sealant are coated on a non-display region provided in the color filter array of the second substrate (step S8). Alternatively, the liquid crystal may be drop-filled on the display region provided in the second substrate and the short and sealant may be coated on a non-display region provided in the first substrate.

A short that is a conductive material such as Ag is coated on the non-display region provided in the color filter array of the second substrate. Thereafter, a sealant such as an epoxy resin is coated on the non-display region provided in the color filter array of the second substrate.

At this point, the order of coating the short and sealant may be changed

Next, the first substrate where the liquid crystals are drop-filled and the second substrate where the short and sealant are coated are assembled (step S9).

The first and second substrates are assembled by loading them on an assembling device. Then the liquid crystals are spread evenly into a closed region provided in a vacuum by the sealant. However, even if a misalignment of the first and second substrates is generated by the assembling device, light leakage caused by the assembly defect will not occur because the LCD device of the present exemplary embodiment has a configuration wherein both sides of one area of the pixel electrode overlap the data line and the dummy gate pattern and both sides of another area of the pixel electrode overlap the storage line.

Thereafter, the sealant of the first and second substrates is thermally hardened (step S10).

The sealant is thermally hardened by applying heat and pressure to the assembled first and second substrates. For instance, the thermal hardening is conducted under a temperature of about 120° C. for an hour. The first and second substrates are then cooled at room temperature. The nematic liquid crystals before heat is applied are transformed into an isotropic state. However, after applying heat and the liquid crystals return back to the nematic state at room temperature a more uniform alignment of the liquid crystal can be obtained.

The assembled first and second substrates are broken to form an LCD panel (step S11).

The assembled first and second substrates are loaded on a glass scriber and broken in any one of x and y directions. The broken substrates are rotated by about 90 degrees and are again broken, thereby forming the LCD panel.

Next, the uneven side surfaces of the LCD panel are ground (step S12).

The LCD panel is loaded on a grinding device and the uneven side surfaces of the broken parts of the LCD panel are uniformly ground.

Thereafter, the LCD panel is subjected to inspection (step S13) and the LCD panel of good quality is handed over to a module process, thereby fabricating the LCD device (step S14).

The LCD panel is loaded on an automatic probe station and an image pattern is displayed by contacting a pad of the LCD panel with a zig where gate driving and data driving circuits for driving the LCD panel are installed. The state of the LCD panel is inspected by changing the image pattern by visual inspection and the LCD panel is divided according to grade. Next, the LCD panel having good quality is handed over to a module process.

As described above, the LCD device of the exemplary embodiments is configured such that both sides of one area of the pixel electrode overlaps the data line and the dummy gate pattern and both sides of another area of the pixel electrode overlaps the storage line. Consequently, a high aperture ratio is provided by the exemplary embodiments by eliminating the top, bottom, right and left margin caused by a misalignment of the assembling device during an assembly process. Further, since, in the exemplary embodiments, the size of the storage electrode can be formed smaller due to the thick line width of the storage line, a high aperture ratio can also be provided. Moreover, in the exemplary embodiments, as the black matrix overlaps only the channel region of the TFT substrate, a high aperture ratio can also be provided and the light leakage current does not occur at the channel.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A liquid crystal display (LCD) device, comprising:
a first substrate and a second substrate;
a gate line formed on the first substrate;
a data line formed on the first substrate, the data line intersecting the gate line;
a thin film transistor (TFT) formed on the first substrate and connected to the gate line and to the data line;
a storage line formed on the first substrate, the storage line being parallel with the gate line;
a pixel electrode formed on the first substrate and connected to a drain electrode of the TFT;
a black matrix formed on the second substrate, the black matrix overlapping a channel of the TFT; and
wherein the pixel electrode comprises two separate pixel electrodes that are adjacent to each other in a longitudinal direction on the storage line.

2. The LCD device of claim 1, wherein the pixel electrode overlaps a region between the gate line, and a storage electrode connected to the storage line.

3. The LCD device of claim 1, further comprising an organic insulating layer formed on the first substrate for insulating the pixel electrode from the data line.

4. The LCD device of claim 3, further comprising a dummy gate pattern that is formed on the first substrate, overlaps the data line, and has a line width wider than that of the data line.

5. The LCD device of claim 4, wherein the line width of the data line is about 2 to about 10 μm and the line width of the dummy gate pattern is about 6 to about 14 μm.

6. The LCD device of claim 4, wherein both sides of the pixel electrode overlap at least one of the data line and the dummy gate pattern.

7. The LCD device of claim 1, further comprising a storage capacitor formed on the first substrate.

8. The LCD device of claim 1, further comprising a plurality of color filters that are formed on the second substrate, overlap the pixel electrode, and are separated from each other at predetermined intervals at a region corresponding to at least one of the data line and the storage line.

9. A liquid crystal display (LCD) device, comprising:
a thin film transistor (TFT) substrate including a first substrate, a gate line and a data line that are formed on the first substrate and intersect each other, a storage line parallel with the gate line, a TFT connected to the gate line and the data line, and a pixel electrodes connected to a drain electrode of the TFT; and
a color filter substrate including a second substrate facing the first substrate with a liquid crystal material disposed therebetween, and a black matrix overlapping a channel of the TFT;
wherein the pixel electrode comprises two separate pixel electrodes that are adjacent to each other in a longitudinal direction on the storage line.

10. The LCD device of claim 9, wherein the two pixel electrodes of the TFT substrate overlaps a region between the gate line, and a storage electrode connected to the storage line.

11. The LCD device of claim 9, wherein the TFT substrate further comprises an organic insulating layer for insulating the two pixel electrodes from the data line.

12. The LCD device of claim 11, wherein the TFT substrate further comprises a dummy gate pattern that overlaps the data line and has a line width wider than that of the data line.

13. The LCD device of claim 12, wherein both sides of the two pixel electrodes overlap at least one of the data line and the dummy gate pattern.

14. The LCD device of claim 9, wherein the TFT substrate further comprises the storage capacitor formed on the first substrate

15. The LCD device of claim 9, wherein the color filter substrate further comprises a plurality of color filters which overlap the two pixel electrodes and are separated from each other at predetermined intervals at a region corresponding to at least one of the data line and the storage line.

16. A method of fabricating a liquid crystal display (LCD) device, comprising the steps of:
preparing a thin film transistor (TFT) array on a first substrate, the TFT array comprising a gate line and a data line intersecting each other, a storage line parallel with the gate line, a TFT connected to the gate line and the data line, and a pixel electrode connected to a drain electrode of the TFT;
preparing a color filter array on a second substrate, the color filter array comprising a black matrix overlapping a channel of the TFT; and
assembling the first and second substrates with a liquid crystal material disposed therebetween;
wherein the pixel electrode comprises two separate pixel electrodes that are adjacent to each other in a longitudinal direction on the storage line.

17. The method of claim 16, wherein preparing the TFT array on the first substrate comprises:
forming a gate pattern comprising the gate line, a gate electrode of the TFT, the storage line and a storage electrode;
forming a gate insulating layer to cover the gate pattern;
forming an active layer of the TFT and an ohmic contact layer on the gate insulating layer;
forming a data pattern comprising the data line, a source electrode of the TFT and the drain electrode of the TFT on the first substrate where the active layer and the ohmic contact layer are formed;
forming an organic insulating layer to cover the data pattern; and
forming the two pixel electrodes on the organic insulating layer.

18. The method of claim 17, wherein preparing the TFT array on the first substrate further comprises at the same time when forming the gate pattern, forming a dummy gate pattern that overlaps the data line and has a line width wider than that of the data line.

19. The method of claim 18, wherein forming the two pixel electrodes includes forming the two pixel electrodes such that both sides of the pixel electrodes overlap at least one of the data line and the dummy gate pattern.

20. The method of claim 17, wherein forming the two pixel electrodes includes forming the pixel electrodes such that the two pixel electrodes overlap a region between the gate line and the storage electrode connected to the storage line.

21. The method of claim 17, wherein preparing the TFT array on the first substrate further comprises forming a storage capacitor formed by overlapping the storage electrode connected to the storage line and the drain electrode of the TFT with an insulating layer of at least one layer.

22. The method of claim 16, wherein preparing the color filter array on the second substrate further comprises forming a plurality of color filters that overlap the two pixel electrodes and are separated from each other at predetermined intervals at a region corresponding to at least one of the data line and the storage line.
